(19) United States
(12) Patent Application Publication
(10) Pub. No.: US 2023/0003989 A1
(43) Pub. Date: Jan. 5, 2023

(54) METHOD FOR CONFIGURING AN AUTOMATED MICROSCOPE, MEANS FOR IMPLEMENTING THE METHOD, AND MICROSCOPE SYSTEM

(71) Applicant: LEICA MICROSYSTEMS CMS GMBH, Wetzlar (DE)

(72) Inventor: Jan BRAUN, Gruenberg (DE)

(21) Appl. No.: 17/783,963

(22) PCT Filed: Dec. 11, 2020
(86) PCT No.: PCT/EP2020/085820

§ 371 Date: Jun. 9, 2022

(30) Foreign Application Priority Data
Dec. 12, 2019 (DE) 10 2019 134 217.1

(51) Int. Cl. G02B 21/36; G02B 21/24

(52) U.S. Cl. CPC G02B 21/365; G02B 21/241

(57) ABSTRACT

A method for configuring a sequence controller of an automated microscope includes, in a learning operating mode, performing training settings in succession. Each training setting corresponds to a respective setting data set of microscope components. A user brings at least a part of the microscope components into positions, and assigns each respective position to one or more examination steps to be performed by the microscope components. The method further includes assessing the training settings after the training settings are performed, and based on the assessment, storing the setting data sets associated with the training settings for subsequent use in the sequence controller, and/or discarding the setting data sets, and/or modifying the setting data sets. The sequence controller specifies a use of the stored setting data sets in the form of a setting of the microscope components in an examination operating mode following the learning operating mode.

### CROSS REFERENCE TO RELATED APPLICATIONS

This application is a U.S. National Phase application under 35 U.S.C. § 371 of International Application No. PCT/EP2020/085820, filed on Dec. 11, 2020, and claims benefit to German Patent Application No. DE 10 2019 134 217.1, filed on Dec. 12, 2019. The International Application was published in German on Jun. 17, 2021 as WO 2021/116439 A1 under PCT Article 21(2).

### FIELD

Embodiments of the present invention relate to a method for configuring a sequence controller of an automated microscope, means for implementing a corresponding method, and a microscope system configured for implementing the method.

### BACKGROUND

In the course of experiments in microscopy, it is often necessary to examine a sample to be examined in succession or sequentially using different settings and/or at different positions and to analyze and assess corresponding results.

Corresponding positions comprise in particular different positions in the plane of a microscope table, also referred to as x/y positions, which can be approached in automated microscopes by a corresponding motorized adjustment of a cross table, also referred to as an x/y table, but also different distances of the objective to the object, also referred to as y positions, which can be set in such automated microscopes by a corresponding motorized adjustment of a focus drive. In each case, corresponding different positions, in addition to an automated setting in the scope of a so-called sequence controller, can also be set manually.

A “sequence controller” is understood here, as is typical among experts and also defined, for example, in F. Tröster, “Regelungs- und Steuerungstechnik für Ingenieure: Band 2: Steuerungstechnik [regulation and control technology for engineers: volume 2: control technology]”, De Gruyter, 2015, as a controller in particular having an inevitable step-by-step sequence, in which advancing from one step to the following one according to the program takes place in dependence on advancing conditions. The steps typically correspond here to successive states of the device to be controlled, in the present case successive settings of an automated microscope. The advancing conditions can be predetermined by the device to be controlled, in which case this is also referred to as a process-controlled sequence controller. In the present case, for example, if a recording was performed of a specific object region or in a specific focus position, it is possible to pass to the next step. In a time-controlled sequence controller, the advancing conditions are solely dependent on the time. Mixed forms are also possible.

The term “object” is to be understood broadly here and relates to any arbitrary object which can be introduced into microscope and examined therein, which can be prepared in an arbitrary manner for the microscopy. For example, it can involve biological objects in the form of sections or smears, but also nonbiological natural objects such as rocks or minerals and artificially produced objects, for example wafers. The present invention is suitable in principle for all areas of microscopy, which can be implemented, for example, in incident light, transmitted light, using illumination and/or detection in the visible wavelength range and/or using fluorescent illumination and/or fluorescence detection and in the wide field or by scanning.

To be able to correctly activate different microscopes by means of software, this software, as specified in DE 10 2008 016 262 B4, requires items of information about the device configuration of the microscope to be activated. Corresponding data can be ascertained by means of an automatic search, which does not always have to lead to the correct results, however.

Therefore, a method is proposed in this document in one embodiment in which, when it is established upon the query of the hardware to recognize device components that these device components were not unambiguously recognized or excluded, the microscope user is asked for corresponding information in that the alternatives coming into consideration for the device components are listed, for example, in a dialogue window in the microscope control software and the microscope user can then decide which alternatives are applicable. After a decision of the microscope user, either a part of the alternatives can already be excluded or new device components can be added to the list of the remaining components here, so that after passing through the configuration files, a new complete device configuration is created for the microscope to be activated.

DE 10 2008 016 262 B4 thus provides a method which defines the fundamental configuration of a microscope so that the foundations are provided for a later activation. Specific settings are not performed here. A device and a method for configuring a microscope are also described in EP 1 697 782 A1. The invention therein is based on the object of providing a device for training and configuring individual components of an at least partially automated microscope. The stand of the microscope is to be capable here of reacting automatically to different microscopy methods.

To achieve this object, it is proposed in the cited document that a device for configuring an at least partially automated or motorized microscope be provided, wherein the microscope has at least one configurable assembly having multiple positions for different elements, wherein a computer having a display and at least one input means is associated with the microscope, and wherein a database is implemented in the computer, in which all possible and available elements for the at least one configurable assembly are stored.

In the abovementioned method, corresponding configuration settings are performed for a user via a user interface before a corresponding experiment is implemented using the microscope.

As described, for example, in U.S. Pat. No. 7,593,158 B2, for example, wavelengths or wavelength ranges can be set in a corresponding automated microscope in dependence on an examination method to be performed. A corresponding automatic optimization can also be performed here. A microscope is disclosed in DE 103 61 158 B4, in which multiple assemblies can be configured using a user interface. DE 39 33 064 C2 discloses a method, in which user-specific and sample-specific presets of a microscope can be performed by means of a control device.

DE 10 2012 219 775 A1 proposes the creation of a sequence for automatically recording images using a recording device, for example, a microscope. By means of a setting unit, an experimental sequence for implementing a complex experiment having various recording dimensions (time, dimension in x, y, and z directions, colors and contrast, etc.) is to be able to be established by the user before beginning the experiment, as it is then later automatically executed. A time interval or the total recording duration (or the number of the points in time) of a time series can thus be defined. It is also possible to define multiple positions on the preparation in the x, y, and z directions (three-dimensionally), arranged in the x and y and/or z direction, in which the sample is traveled along during the image recording, fixed exposure times, and/or a laser or LED intensity for various recording channels.

As claimed in this document, according to step a), a recording program is set.

According to a step b), a parameter to be monitored is specified or selected. According to step c), conditions with respect to the parameter and actions in dependence on meeting the conditions can also be specified. According to step c), a sequence controller is defined on this basis. This procedure corresponds to a previous definition known per se of a sequence of settings, but expanded by the monitoring of a parameter and corresponding reactions. In this way the sequence—which is still completely specified in the conventional manner, however—can be expanded by corresponding conditions.

The cited documents thus disclose, on the one hand, the provision of the most complete possible and correct items of configuration information, which can underlie an automatic activation, and, on the other hand, the pre-definition of an automatic sequence, possibly expanded by the evaluation of a parameter and a corresponding reaction thereto. However, the creation of the automatic sequence itself is not changed in this way.

### SUMMARY

A method for configuring a sequence controller of an automated microscope includes, in a learning operating mode, performing training settings automatically or manually in succession. Each training setting corresponds to a respective setting data set of microscope components of the microscope. A user brings at least a part of the microscope components into positions, each respective position corresponding to a specific sample region and/or a specific focus position, and assigns each respective position to one or more examination steps to be performed by the microscope components. The method further includes assessing the training settings automatically or manually after the training settings are performed, and based on the assessment, storing the setting data sets associated with the training settings for subsequent use in the sequence controller, and/or discarding the setting data sets, and/or modifying the setting data sets. The sequence controller specifies a use of the stored setting data sets in the form of a setting of the microscope components according to the setting data sets in an examination operating mode following the learning operating mode.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an automatable upright microscope system usable in the scope of one embodiment of the present invention;

FIG. 2 shows an automatable inverse microscope system usable in the scope of one embodiment of the present invention;

FIG. 3 shows an automatable microscope system usable in the scope of one embodiment of the present invention in another representation; and

FIG. 4 illustrates a method according to one embodiment of the present invention in a training operating mode.

### DETAILED DESCRIPTION

Embodiments of the present invention can make the configuration of a sequence controller of an automated microscope easier and more user-friendly, and in this way providing an improved automated microscope system.

Embodiments of the present invention provide a method for configuring a sequence controller of an automated microscope having activatable microscope components, means for implementing a corresponding method, and a microscope system configured for implementing the method having the respective features of the independent claims.

During the configuration of automated microscopes, settings of microscope components or setting sequences in the form of setting values can be stored by the operator, for example. The settings stored in this way can subsequently be reestablished by the user if needed, as already explained in principle with reference to the prior art.

Furthermore, alternatively or additionally to the automated creation of macros, recording the operations effectuated by the user on the microscope and retrieving them if needed is known. Moreover, microscope operations can also be managed by a suitable programming language and converted in the course of a sequence controller by a suitable interpreter into corresponding actions on the microscope.

However, these known methods have disadvantages. In the case of the manual storage of settings of components and their retrieval, a state which is taught and thus stored can possibly be reestablished, however, a sequence controller is not implementable. In the case of the creation of macros, more complex sequences can be recorded and retrieved again, however, there is no possibility of influencing the predefined sequence by way of user interactions, so that incorrect settings can also be performed accordingly. The classic programming does cover all degrees of freedom, however, in general, learning a programming language and having fundamental knowledge of programming are necessary here.

Embodiments of the present invention can overcome these disadvantages in that in the method according to embodiments of the invention, training settings of activatable microscope components, which are each determined in succession in a learning operating mode and correspond to different setting data sets, are automatically or manually performed in that a user brings at least a part of the microscope components into positions which each correspond to a specific sample region and/or a specific focus position, and assigns each of these positions to one or multiple examination steps to be performed by means of the mentioned or arbitrary further microscope components, and in which the training settings are automatically or manually assessed after performing the training settings.

The microscope components brought by the user into the mentioned positions can in particular be a sample table, which positions the sample in relation to the objective in the X, Y, and Z directions, so that the sample region located in the observation field of the objective is secured both with respect to its lateral position and also its focus position. However, these can also be any arbitrary other components which permit such positioning. When reference is made here to the user “bringing” the corresponding microscope components, this can take place by a direct action (for example, by manual adjustment at the respective component) or an indirect action (for example, via an adjustment mechanism or by means of activation signals at motors).

The examination step or steps which can take place using the same or arbitrary further microscope components in arbitrary combination are, for example, examination steps which can comprise specific illumination methods (transmitted light, incident light, fluorescent illumination, bright field illumination, dark field illumination, phase contrast illumination, etc.) and illumination intensities (for example, an examination using lesser and stronger illumination in succession), illumination patterns (for example, examination using fluorescent light, then light in the visible range, then by means of a specific illumination method or, for example, in the form of a scanning sampling such as a spiral scan). In addition to the illumination, for example, a temperature or the like can also be changed. Embodiments of the invention is not restricted by the selection of the specific examination method.

In dependence on this assessment, the setting data sets associated with the training settings are each stored for a following use in the form of a suitable sequence controller, discarded, and/or modified. Complex sequence controllers can then be defined by stringing together the stored training settings. The sequence controller specifies a use of the stored setting data sets in the form of a setting of the microscope components according to the setting data sets in an examination operating mode following the learning operating mode. The stringing together can take place in a defined sequence which can be specified either by a user or completely automatically.

The sequence controller comprises in particular advancing from one step to a following step according to the program in dependence on advancing conditions in the form of a step-by-step sequence. The steps correspond to successive settings of the microscope according to the respective setting data sets. The advancing conditions can be predetermined in the scope of a process-controlled sequence controller, for example, on the basis of detected sample properties or a return value, according to which a prior step has ended. Alternatively or additionally, in a time-controlled sequence controller, the advancing conditions can be specified solely on the basis of an elapsed time. In the scope of the present invention, a mixed form of a process-controlled and a time-controlled sequence controller is also possible.

A “setting data set” here is to be a data unit provided, output, input, transmitted, or stored in a suitable manner, which has one or multiple setting values with respect to one or respectively one training setting.

In this way, embodiments of the present invention provides a method in which in a chronological sequence, by means of a sequence controller, the setting data sets can be implemented in an examination operating mode following the learning operating mode in succession in settings of specific microscope components and an examination having associated examination steps. In contrast to a manual definition via setting values, in the scope of the present invention, the user does not need to know in detail the setting values provided numerically or in the form of positioning values, for example, and used internally further in this way, rather he solely has to perform corresponding settings, for example, guide a microscope table, change an objective, select an illumination brightness and/or a light color, and/or adjust the focus drive. The method according to embodiments of the invention comprises storing corresponding values corresponding to these training settings in the respective setting data sets so that they are available in a form which can be evaluated and used by a microscope system or a corresponding control unit or a computer and in particular define specific examination modes for corresponding settings.

In contrast to methods of macroprogramming, embodiments of the present invention make it possible, by way of the automatic or manual assessment of setting data sets associated with the respective training settings, only to make available valid or advantageous setting data sets for the subsequent use or if necessary also to modify them for the subsequent use. If the respective setting data sets and the training settings thus achieved are unusable, they can be discarded and a new training setting can be performed, for example, at the same or a different point of the object and/or using the same or different settings of the microscope.

It is particularly advantageous if the examination operating mode comprises one or multiple acquisition steps, in which the one or the multiple examination steps are performed in the respective sample regions and/or using the respective focus positions, wherein image data are obtained and stored by means of the one or multiple acquisition steps. The image data are in particular optimized by the assessment which has already been previously performed.

The image data obtained in the one or multiple acquisition steps and stored are advantageously subjected in one or multiple evaluation steps to an image analysis, which in particular also operates using items of information with respect to the positions and/or the implemented examination steps. In this way, a deliberate evaluation corresponding to the examination method can be performed substantially automatically in the sequence controller.

The implementation of the one or multiple evaluation steps can be initiated as a reaction to a user input or automatically, so that either a user can generate correspondingly evaluated data as needed or the method can be implemented completely automatically. Alternatively or additionally, a user input can be evaluated in the one or multiple evaluation steps, which provides, for example, additional items of information.

The setting data sets or the different training settings can relate in the scope of the present invention, as already mentioned multiple times above, to arbitrary components of a microscope or microscope system. A corresponding microscope or microscope system comprises those components, for example, in the form of one or multiple configurable assemblies, which can have one or multiple different elements, which can be brought into different positions by means of corresponding setting values in the setting data sets used in the scope of the present invention, for example, by means of suitable stepping motors or other electromechanical actuators. This applies accordingly to the examination steps, which can be assigned to the respective positions in the sequence controller. A computer, which is equipped with a display and at least one input means, can be assigned to the microscope or microscope system.

Corresponding components can comprise, for example, a motorized lens barrel and/or a motorized adjustable incident light axis, a motorized objective revolver, a motorized z drive for the focus setting of a motorized cross table, at least one illumination device for the incident light or transmitted light illumination, and/or a condenser and a variety of operating knobs or arbitrary combinations of the mentioned components.

As mentioned, in the method according to embodiments of the invention, in the learning operating modes, training settings of microscope components, which are successively determined and each correspond in succession to different training data sets, are performed automatically or manually and in particular assessed automatically or manually after the performance. The automatic assessment can be performed here, for example, by visually judging an obtained microscope image, but also, for example, by corresponding image processing. In particular, sharpness, contrast, brightness, and/or color values or other image properties, for example, also in the form of a corresponding image comparison to images obtained previously or subsequently, can be judged. Corresponding to these specific expected values, which can be electronically stored, for example, in the form of corresponding threshold values, the setting data sets associated with the training settings can be stored for the subsequent use, otherwise they can be discarded and/or modified if possible in a suitable manner for the subsequent use or for a modified setting of training settings.

Embodiments of the present invention comprises, as mentioned, that a user brings specific or all microscope components into specific positions or guides them to specific positions to perform the training settings, wherein this can comprise that he or she pivots, for example, filters, prisms, beam splitters, or the like, which are attached to an automatically activatable filter wheel or other automatically activatable adjustment devices, but also, for example, objectives of an automatically activatable motorized objective revolver, into the illumination or observation beam path or performs a brightness setting.

The user or a correspondingly automated microscope or microscope system thereupon performs an assessment of the training settings performed in this way on the basis of the mentioned criteria. Depending on the result of this assessment, it can be ensured by a corresponding manual or automated confirmation that the microscope or microscope system “notes” the setting values, which are used for the corresponding training settings but are not directly input by the user or saved in a file, in corresponding setting data sets, so that they are available for the subsequent examination operating mode. The subsequent examination operating mode can use the individual setting data sets, in particular in the form of an at least partially automated sequence controller, which can, however, offer arbitrary user interaction options, of course, for example, to stop or run in a modified manner a corresponding sequence and/or to change setting values. In this way, a particularly flexible method can be provided in the scope of the present invention.

Embodiments of the present invention also extend to a microscope system having a microscope and a control device, which is configured to operate the microscope in a learning operating mode and in an examination operating mode, wherein the microscope system is configured, in the learning operating mode, to automatically or manually perform training settings of microscope components, which are successively determined and each correspond in succession to different setting data sets, in that a user brings at least a part of the microscope components into positions which each correspond to a specific sample region and/or a specific focus position, and assigns each of these positions to one or multiple examination steps to be performed by the or further microscope components (2-53), and to assess the training settings automatically or manually after the performance, and in dependence on the assessment, to store the setting data sets associated with the training settings in each case for a subsequent use in a sequence controller, to discard them, and/or to modify them, wherein the sequence controller is configured to use the stored setting data sets in the form of a specification of a setting of the microscope components according to the setting data sets in an examination operating mode following the learning operating mode.

As mentioned, embodiments of the present invention can be implemented using greatly varying microscopy methods and correspondingly configured microscopes, for example, using incident light, transmitted light, light sheet, (laser) scanning, or fluorescence microscopes. The more complexly corresponding microscopes are constructed, the greater the extent to which they profit from the measures proposed here.

Embodiments of the present invention furthermore relate to a control unit for a microscope or microscope system, which can be configured to implement a method as was explained above in different embodiments. Reference is therefore expressly made here to the corresponding explanations. This also applies to the proposed computer program or a corresponding computer program product stored on a data carrier or a server or the like.

Some or all method steps can be executed in the scope of the invention by (or using) a hardware device, for example, comprising a processor, a microprocessor, a programmable computer, or an electronic circuit. In some exemplary embodiments, one or multiple of the most important method steps can be executed by such a device.

Exemplary embodiments of the invention can be implemented in hardware or software in dependence on specific implementation requirements. The implementation can be carried out using a nonvolatile storage medium, for example, a diskette, a DVD, a Blu-ray disc, a CD, a ROM, a PROM and EPROM, an EEPROM, or a FLASH memory, on which electronically readable control signals are stored, which interact (or can interact) with a programmable computer system so that the respective method is implemented. The storage medium can therefore be computer-readable.

Some exemplary embodiments comprise a data carrier having electronically readable control signals, which can interact with a programmable computer system so that one of the methods described herein is implemented.

In general, exemplary embodiments of the present invention can be implemented as a computer program product having a program code, wherein the program code acts to execute one of the methods when the computer program product runs on a computer. The program code can be stored, for example, on a machine-readable carrier.

Further exemplary embodiments comprise the computer program for implementing one of the described methods, which is stored on a machine-readable carrier.

In other words, one embodiment of the present invention is therefore a computer program having a program code for implementing one of the methods described herein when the computer program runs on a computer.

A further exemplary embodiment of the present invention is therefore a storage medium (or a data carrier or a computer-readable medium), which comprises a computer program stored thereon for executing one of the methods described herein when it is executed by a processor. The data carrier, the digital storage medium, or the recorded medium are generally tangible and/or not seamless. A further exemplary embodiment of the present invention is a device as described herein, which comprises a processor and the storage medium.

A further exemplary embodiment of the invention is therefore a data stream or a signal sequence which represents the computer program for implementing one of the methods described herein. The data stream or the signal sequence can be configured, for example, so that they are transferred via a data communication connection, for example, via the Internet.

A further exemplary embodiment comprises a processing means, for example, a computer, a control unit, or a programmable logic device, which is configured or adapted to execute one of the methods described herein.

A further exemplary embodiment of the invention comprises a computer on which the computer program for executing one of the methods described herein or arbitrary embodiments thereof is installed.

A further exemplary embodiment according to the invention comprises a device or a system which is configured to transfer (for example, electronically or optically) a computer program for executing one of the methods described herein to a receiver. The receiver can be, for example, a computer, a mobile device, a storage device, or the like. The device or the system can comprise, for example, a file server for transferring the computer program to the receiver.

In some exemplary embodiments of the invention, a programmable logic device (for example, a field-programmable gate array, FPGA) can be used to execute some or all functionalities of the methods described herein. In some exemplary embodiments, a field-programmable gate array can cooperate with a microprocessor to implement one of the methods described herein. In general, the methods are preferably implemented by any hardware device.

Exemplary embodiments of the present invention can be based on the use of a machine learning model or machine learning algorithm. The assessment performed according to the invention can be affected hereby in particular. Machine learning can relate to algorithms and statistical models which computer systems can use to execute a specific task without using explicit instructions, instead of relying on models and interference.

In machine learning, for example, instead of a transformation of data based on rules, a transformation of data can be used which can be derived from an analysis of profile and/or training data. For example, the content of images can be analyzed using a machine learning model or using a machine learning algorithm and the assessment according to the invention can thus be performed.

In order that the machine learning model can analyze the content of an image, for example, the machine learning model can be trained using training images as the input and training content information as the output. By training the machine learning model using a large number of training images and/or training sequences (for example, words or sentences) and associated training content information (for example, identifiers or remarks), the machine learning model “learns” to recognize the content of the images so that the content of images which are not comprised in the training data can be recognized using the machine learning model. The same principle can also be used for other types of sensor data: By training a machine learning model using training sensor data and a desired output, the machine learning model “learns” a conversion between the sensor data and the output which can be used to provide an output based on non-training sensor data provided to the machine learning model. The provided data (e.g., sensor data, metadata, and/or image data) can be preprocessed to obtain a feature vector, which is used as the input for the machine learning model.

Machine learning models can be trained using training input data. The above-mentioned examples use a training method called “supervised learning”. In supervised learning, the machine learning model is trained using a plurality of training sample values, wherein each sample value can comprise a plurality of input data values and a plurality of desired output values, i.e., a desired output value is assigned to each training sample value. By specifying both training sample values and also desired output values, the machine learning model “learns” which output value is to be provided based on an input sample value, which is similar to the sample values provided during the training. In addition to supervised learning, semi-supervised learning can also be used. In semi-supervised learning, some of the training sample values lack a desired output value. Supervised learning can be based on a supervised learning algorithm (e.g., a classification algorithm, a regression algorithm, or a similarity learning algorithm). Classification algorithms can be used when the outputs are restricted to a limited set of values (categorical variables), i.e., the input is classified as one from the limited set of values. Regression algorithms can be used when the outputs have any numeric value (within a range). Similarity learning algorithms can be similar to both classification algorithms and also regression algorithms, but are based on the learning from examples using a similarity function, which measures how similar or related two objects are. In addition to supervised learning or semi-supervised learning, unsupervised learning can be used to train the machine learning model. In unsupervised learning, possibly (only) input data are provided and an unsupervised learning algorithm can be used to find a structure in the input data (for example, by grouping or clustering the input data, finding commonalities in the data). Clustering is the assignment of input data which comprise a plurality of input values into subsets (clusters), so that input values within the same cluster are similar according to one or multiple (predefined) similarity criteria, while the input values which are comprised in other clusters are dissimilar.

Reinforcing learning is a third group of machine learning algorithms. In other words, reinforcing learning can be used to train the employed machine learning model. In reinforcing learning, one or multiple software agents are trained to perform actions in an environment. A reward is calculated based on the performed actions. Reinforcing learning is based on the training of the one or multiple software agents to select the actions in such a way that the cumulative reward is increased, which results in software agents which become better in the task given to them (as proven by increasing rewards).

Furthermore, some technologies can be applied to several of the machine learning algorithms. For example, feature learning can be used. In other words, the machine learning model can be trained at least partially using feature learning, and/or the machine learning algorithm can comprise a feature learning component. Feature learning algorithms, which are called representation learning algorithms, can receive the information in their input, but transform it in such a way that it is useful, often as a preprocessing step before the execution of the classification or the prediction. Feature learning can be based, for example, on main component analysis or cluster analysis.

In some examples, anomaly detection (i.e., outlier detection) can be used which is intended to provide an identification of input values which raise suspicion that they differ significantly from the majority of input and training data. In other words, the machine learning model can be trained at least partially using anomaly detection, and/or the machine learning algorithm can comprise an anomaly detection component.

In some examples, the machine learning algorithm can use a decision tree as a prediction model. In other words, the machine learning model can be based on a decision tree. In a decision tree, the observations of an object (for example, a set of input values) can be represented by the branches of the decision tree and an output value which corresponds to the object can be represented by the leaves of the decision tree. Decision trees can support both discrete and also progressive values as output values. If discrete values are used, the decision tree can be referred to as a classification tree, if progressive values are used, in contrast, the decision tree can be referred to as a regression tree.

Association rules are a further technology which can be used in machine learning algorithms. In other words, the machine learning model can be based on one or multiple association rules. Association rules are created in that relationships between variables are identified in large amounts of data. The machine learning algorithm can identify and/or use one or multiple relationship rules which represent the knowledge that is derived from the data. The rules can be used, for example, to store, manipulate, or apply the knowledge.

Machine learning algorithms are normally based on a machine learning model. In other words, the term “machine learning algorithm” can refer to a set of instructions which can be used to create, train, or use a machine learning model. The term “machine learning model” can refer to a data structure and/or a set of rules which represents the trained knowledge (for example, based on the training executed by the machine learning algorithm). In exemplary embodiments, the use of a machine learning algorithm can imply the use of an underlying machine learning model (or a plurality of underlying machine learning models). The use of a machine learning model can imply that the machine learning model and/or the data structure/the set of rules which is/are the machine learning model is trained by a machine learning algorithm.

For example, the machine learning model can be an artificial neural network (ANN). ANN are systems which are inspired by biological neural networks as can be found in a retina or a brain. ANN comprise a plurality of interconnected nodes and a plurality of connections, so-called edges, between the nodes. There are normally three types of nodes, input nodes, which receive input values, concealed nodes, which are (only) connected to other nodes, and output nodes, which provide output values. Each node can represent an artificial neuron. Each edge can send information from one node to another. The output of a node can be defined as a (nonlinear) function of the inputs (for example, the sum of its inputs). The inputs of a node can be used in the function based on a “weight” of the edge or the node which provides the input. The weight of nodes and/or of edges can be adapted in the learning process. In other words, the training of an artificial neural network can comprise an adaptation of the weights of the nodes and/or edges of the artificial neural network, i.e., to achieve a desired output for a specific input.

Alternatively, the machine learning model can be a support vector machine, a random forest model, or a gradient boosting model. Support vector machines (i.e., support vector networks) are supervised learning models having assigned learning algorithms which can be used to analyze data (for example, in a classification analysis or regression analysis). Support vector machines can be trained by providing an input having a plurality of training input values which belong to one of two categories. The support vector machine can be trained to assign one of the two categories a new input value. Alternatively, the machine learning model can be a Bayesian network, which is a probabilistic, directed, acyclic graphic model. A Bayesian network can represent a set of random variables and their conditional dependencies using a directed acyclic graph. Alternatively, in the scope of the present invention, the machine learning model can be based on a genetic algorithm which is a search algorithm and heuristic technology that imitates the process of natural selection.

The term “and/or” when used above, comprises all combinations of one or multiple of the associated listed elements.

Although some aspects of the present invention were described above in conjunction with the method, it is obvious that the corresponding description also applies to a corresponding device and vice versa, wherein a method step can be implemented, for example, using a corresponding device component.

The invention and embodiments of the present invention are explained in more detail hereinafter with reference to the appended drawings.

In the figures, elements corresponding to one another, i.e., identically or similarly constructed elements, or elements having identical or comparable effect are indicated by identical reference signs and are not explained repeatedly for the sake of clarity.

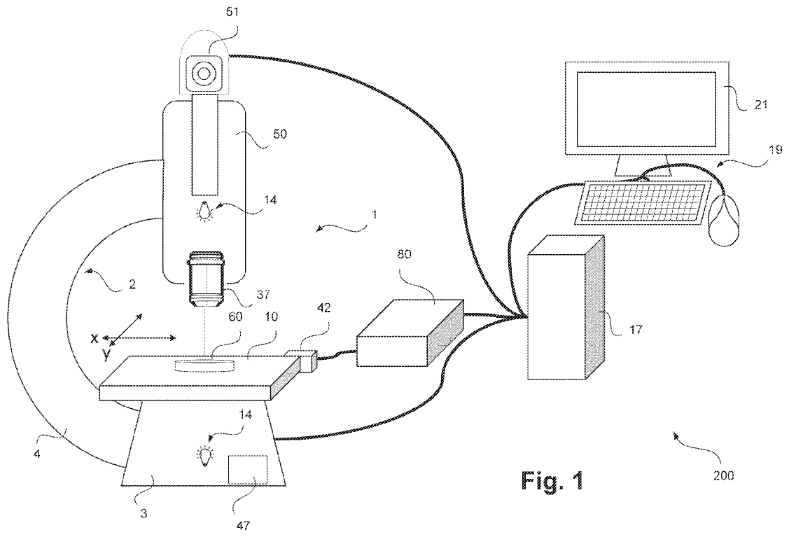

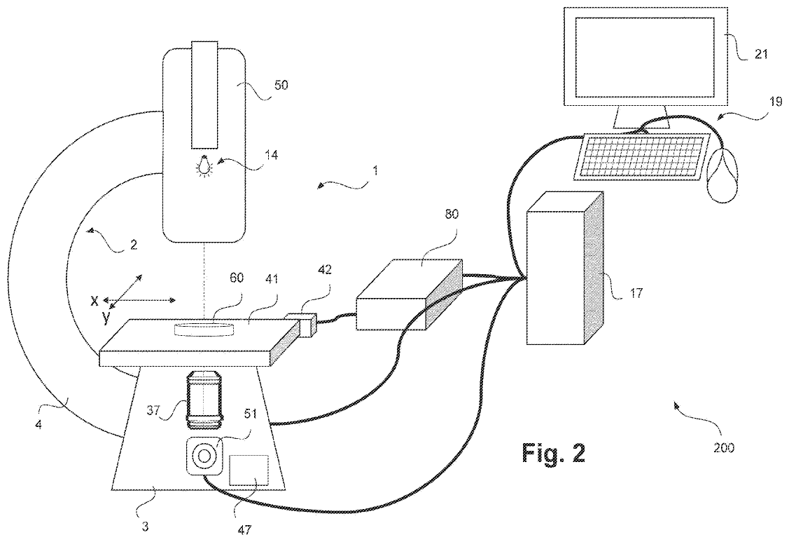

FIGS. 1 and 2 show automatable microscope systems, identified by 200, usable in the scope of embodiments of the present invention. The microscopes are each identified by 1, wherein FIG. 1 shows an upright microscope 1, while FIG. 2 shows an inverse microscope 1. The microscopes 1 each comprise a stand 2, which in the embodiments shown in FIGS. 1 and 2 has a stand base 3 and a stand column 4 in each case.

According to FIG. 1, two light sources 14 are or, according to FIG. 2, one light source is provided to generate an incident and transmitted light illumination in the embodiment according to FIG. 1 or only to generate a transmitted light illumination in the embodiment according to FIG. 2. A microscope table 41 is provided, on which, for example, a filter holder (not shown separately) can also be provided, and which is movable by means of a motor 42. Data can be stored in an internal memory 47 of the microscope 1.

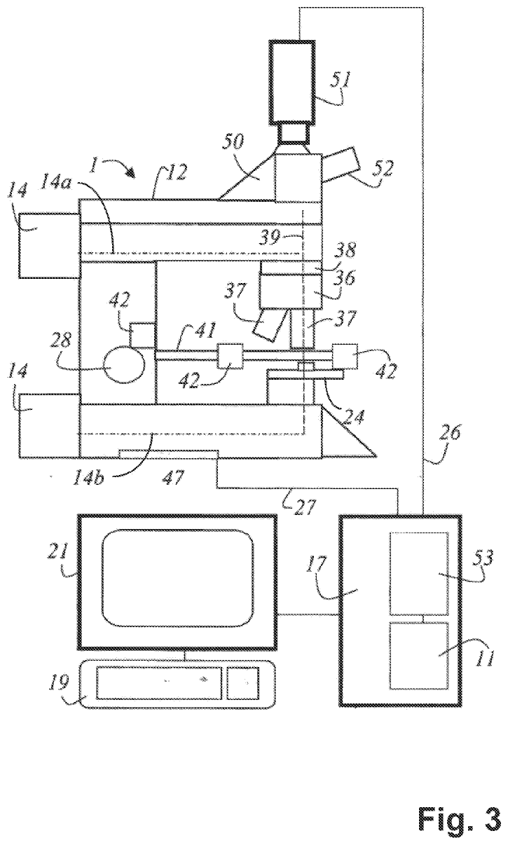

In the embodiments according to FIGS. 1 and 2, drive knobs 28 can be provided on both sides of the stand 2, as is only illustrated in FIG. 3, however, by which, for example, a microscope table 41 can be adjusted in its height (z direction). It is also conceivable to additionally place other functions on the drive knobs 28 as well. Multiple operating knobs (not shown in FIGS. 1 and 2) can also be provided in the region around the drive knobs 28, via which microscope functions are also switchable. The microscope functions are, for example, filter change, aperture selection, revolver movement, etc. An objective 37 can optionally be attached in an object revolver 36 (not shown) (see FIG. 3 in this regard). A condenser 24 can also be provided opposite to the object revolver 36 (also see FIG. 3 in this regard).

Furthermore, a computer 17 is assigned to the microscope 1. The computer 17 is provided with input means 19 and a display 21. In the exemplary embodiment illustrated here, the input means 19 comprise a keyboard and a mouse. However, it is obvious that further input means 19 can be used in addition to a keyboard. The computer 17 represents a control device here; however, any other control devices integrated in the microscope 1 or external control devices 80 can also be provided. According to FIG. 1, a suitable camera 51 is arranged on a lens barrel 51 or a corresponding camera outlet, which camera is located according to FIG. 2 in the stand base 3. A sample is identified by 60.

FIG. 3 schematically shows an automatable microscope system usable in the scope of an embodiment of the present invention having a microscope 1. It can also be each of the microscope systems shown in FIGS. 1 and 2, which are schematically shown once again here and explained in more detail.

The microscope 1 and the various configurable assemblies of the microscope 1 are illustrated here partially more schematically than previously. Each of these assemblies can represent a component or microscope component, which can be set in the scope of the invention, for which purpose the corresponding setting data sets can be used. The term “assembly” can therefore stand hereinafter for one or multiple such microscope components, which are settable according to the invention or for which setting data can be generated in corresponding setting data sets. If reference is made hereinafter to “training” of one or multiple components, this can take place using a method according to one embodiment of the invention and can comprise the steps mentioned multiple times for creating the training data sets.

One of the configurable assemblies is the abovementioned object revolver 36. By way of a method according to the present invention, for example, setting data sets can be used which correspond to or have data for each individual objective 37 or which specify the selection of a corresponding objective 37. The objective revolver 36 is motorized and is rotated by a motor 38, so that a selected objective can be brought into the optical axis 39 of the microscope. The data which characterize each objective 37 are the objective magnification, the article number of the objectives (a unique key for the respective order processing), the objective mode (for example, dry objective, immersion objective, or a combination of dry objective and immersion objective), the aperture, the optimal step width in the z direction for the respective objective 37 (focus), and the optimal step width for an x/y displacement for the respective objective (cross table). The cross table 41 is assigned to the microscope 1 and a sample (not shown in FIG. 3) placed on the cross table 41 can be moved in a desired direction by means of the cross table. A motor 42 is provided in each case to move the cross table 41 in the z direction (focus) and in the x and y directions. The adjustment of the cross table 41 in the z direction can in addition also be performed at any time, of course, manually using the drive knob 28.

Furthermore, the illumination methods to be carried out using the respective objective 37 are also trained or a setting data set used in one embodiment of the invention can comprise activation or setting values for the illumination. Corresponding thereto, a lamp 14 is assigned to the microscope 1 in each case for an incident light axis 14a and a transmitted light axis 14b. The illumination methods supported by the objectives 37 can comprise, for example, a bright field, a fluorescence difference contrast, a fluorescence phase contrast, a fluorescence, an incident light polarization contrast, an incident light difference contrast, an incident light dark field, an incident light oblique light, an incident light bright field, a transmitted light polarization contrast, a transmitted light difference contrast, a transmitted light dark field, a transmitted light phase contrast, or a transmitted light bright field illumination. The values of the light sources 14 for the individual illumination methods are also trained or the setting data sets used in the scope of the present invention can relate thereto.

In addition, there are the values for the aperture stop for transmitted light for the respective method and the field diaphragm for transmitted light for the respective method. Of course, values for the aperture of the stop for incident light for the respective method and the field diaphragm for incident light for the respective method are also trained or the setting data sets used in the scope of the present invention can relate thereto. Depending on the method, the position to be set of an interference contrast pane for the respective method can possibly be trainable or the setting data sets used in the scope of the present invention can relate thereto. Furthermore, the position of the condenser to be set for the respective method can be trained or the setting data sets used in the scope of the present invention can relate thereto.

The data for the illumination axis for fluorescence can also be trained or the setting data sets used in the scope of the present invention can relate thereto. These data are the name of the respective filter block, the article number of the filter block, the illumination method, in which the filter block can be moved into the beam path (or illumination axis) and a so-called dazzle protection.

A wheel position for interference contrast can also be trained or the setting data sets used in the scope of the present invention can relate thereto. For each position, the name of the respective filter block has to be trained.

For the condenser 24 of the microscope 1, the data can be trained for each position or the setting data sets used in the scope of the present invention can relate thereto. This relates, for example, to the name of the prism to be pivoted into the beam path 39 or the name of the phase ring to be pivoted into the beam path 39. Of course, the condenser 24 can also be motorized to thus automatically pivot the prism and the phase ring into the beam path 39 of the condenser.

A magnification changer 46 can also be trained or the setting data sets used in the scope of the present invention can relate thereto. The article number, the number of positions of the magnification changer 46, and the like can be trained here. The magnification values at the corresponding positions in the magnification changer are also to be input or the setting data sets used in the scope of the present invention can relate thereto. In the mentioned upright microscope, the magnification changer is located between the lens barrel and the objective revolver in the beam path.

The configuration of the lens barrel 50 of the microscope 1 (motorized and/or mechanical) is trainable or the setting data sets used in the scope of the present invention can relate thereto. An article number of the lens barrel 50 can be input here, for example. The number of the outputs is therefore defining with the lens barrel 50 used. An output for a camera 51 and an output for an eyepiece 52 can be arranged on the lens barrel 50, for example. The light intensity can also be distributed on the various outputs. A distribution of the light intensity would be, for example, 50% of the light intensity on the visual output and the remaining 50% on the output to the photo lens barrel. It can also be important to train the article number of the eyepieces used and possibly also the magnification linked to the eyepieces. The article number of the camera fastening used can possibly also be trained together with the magnification of the camera fastening.

As mentioned, multiple operating knobs 30 or function buttons can be located in the region around the drive knob 28. These function buttons can be assigned differently. Thus, for example, in one configuration in the scope of one embodiment of the invention, a short name of the button assignment can be input. Furthermore, a command which is executed upon button actuation can be defined by a configuration in the scope of one embodiment of the present invention. A command which is triggered upon release of the function button can also be configured accordingly. In addition, there is the command repetition rate upon holding of the function button.

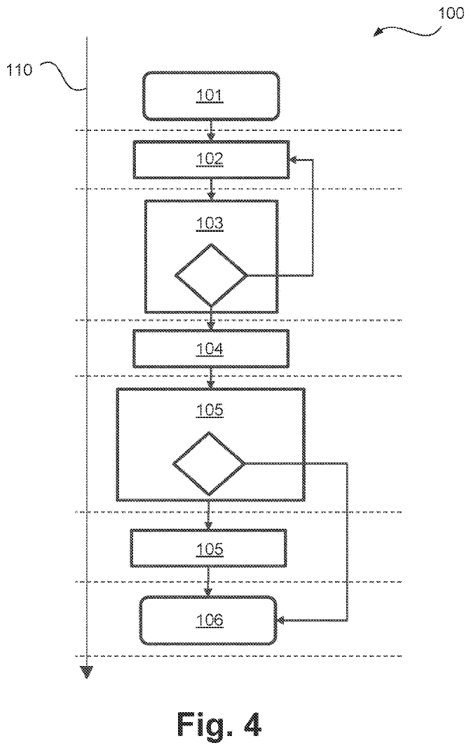

FIG. 4 illustrates a method according to one embodiment of the present invention in a training operating mode and in the form of a schematic flow chart 100 having multiple method steps plotted over a time axis 110.

The method 100 according to the embodiment illustrated here begins with a step 101, for example, with an initialization or the provision of the electronics and software resources required for the method 100. In a step 102, a training setting of microscope components corresponding to a first setting data set, as shown in the above-explained figures, is automatically or manually performed in the above-explained manner. This can involve any ones of the above-explained and any further training settings.

After the training settings are performed in step 102, these training settings are in particular automatically or manually assessed in a step 103. In dependence on this assessment in step 103, the setting data sets associated with the training settings are each stored for a subsequent use in a sequence controller if they correspond to an expected value or the like, or are otherwise discarded and/or modified. In the first case, the method can be continued with performing second training settings in a step 104 or the assessment in a step 105; in the latter case, for example, a renewed (for example modified) performance of the first training settings can be performed in step 103.

The method 100 ends after the performance of arbitrary further training settings and their assessment (summarized here by 105) in a step 106. Subsequently thereto, an examination operating mode can be performed.

In this way, the present invention provides a method in which, in a chronological sequence by means of a sequence controller, the setting data sets can be converted in an examination operating mode following the learning operating mode in succession into settings of specific microscope components. In contrast to a manual definition via setting values, in the scope of the present invention, the user does not need to know in detail the setting values provided numerically or in the form of positioning values and still used internally in this way, for example, rather he only has to perform corresponding settings, for example, guide a microscope table, change an objective, select an illumination brightness and/or a light color, and/or adjust the focus drive. The method according to the invention comprises storing the corresponding values corresponding to these user settings in the respective setting data sets, so that these are provided in a form which can be evaluated and used by a microscope system or a corresponding control unit or a computer.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for configuring a sequence controller of an automated microscope, the method comprising:
in a learning operating mode, performing training settings automatically or manually in succession, each training setting corresponding to a respective setting data, set of microscope components of the microscope, wherein a user brings at least a part of the microscope components into positions each respective position corresponding to a specific sample region and/or a specific focus position, and assigns each respective position to one or more examination steps to be performed by the microscope components
assessing the training settings automatically or manually after the training settings are performed,
based on the assessment, storing the setting data sets associated with the training settings for subsequent use in the sequence controller, and/or discarding the setting data sets, and/or modifying the setting data sets
wherein the sequence controller specifies a use of the stored setting data sets in the form of a setting of the microscope components according to the setting data sets in an examination operating mode following the learning operating mode.

2. The method as claimed in claim 1, wherein the examination operating mode comprises one or more acquisition steps, the one or more acquisition steps are performed in the respective sample regions and/or using the respective focus positions, wherein image data are obtained and stored by the one or more acquisition steps.

3. The method as claimed in claim 2, wherein the image data obtained and stored in the one or acquisition steps are subjected to an image analysis in one or more evaluation steps.

4. The method as claimed in claim 3, wherein an implementation of the one or more evaluation steps is initiated as a reaction to a user input or automatically, wherein the user input is evaluated in the one or more evaluation steps.

5. The method as claimed in claim 1, wherein the use of the setting data sets in the sequence controller comprises stringing together the stored setting data sets.

6. The method as claimed in claim 5, wherein a sequence in which the stored setting data sets are strung together is predeterminable automatically or by a user.

7. The method as claimed in claim 1, wherein the microscope components comprise a motorized lens barrel and/or a motorized adjustable incident light axis, and/or a motorized objective revolver, and/or a motorized z drive for the focus setting, and/or a motorized cross table, and/or at least one illumination device for the incident light or transmitted light illumination, and/or a condenser and/or one or more operating knobs, or a combination thereof.

8. The method as claimed in claim 1, wherein the automatic or manual assessment is implemented by visual judgment of a microscope image obtained using the microscope and/or on the basis of automatic image processing.

9. The method as claimed in claim 8, in which wherein, in the visual judgment or the automatic image processing, sharpness, contrast, brightness, and/or color values or other image properties, in a form of an image comparison to previously or subsequently obtained images, are judged.

10. A microscope system having comprising:
a microscope, and
a control device, which is configured to operate the microscope in a learning operating mode and an examination operating mode, wherein the microscope system is configured to:
in the learning operating mode, automatically or manually perform successively determined training settings, each training setting corresponding to a respective setting data set of microscope components wherein a user brings at least a part of the microscope components into positions, each respective position corresponding to a specific sample region and/or a specific focus position, and assigns each respective position to one or more examination steps to be performed by the microscope components,
automatically or manually assess the training settings after they the training settings are performed, and
based on the assessment, store the setting data sets associated with the training settings for a subsequent use in a sequence controller, and/or discard the setting data sets, and/or modify the setting data sets, wherein the sequence controller is configured to use the stored setting data sets in a form of a specification of a setting of the microscope components according to the setting data sets in an examination operating mode following the learning operating mode.

11. The microscope system as claimed in claim 10, wherein the microscope is designed as an incident light microscope, a transmitted light microscope, a light sheet microscope, a scanning microscope, or a fluorescence microscope.

12. (canceled)

13. A control unit for a microscope system, which is configured to carry out the method as claimed in claim 1.

14. A non-transitory computer-readable medium having processor-executable instructions stored thereon which, when it is executed on a processing unit, facilitate performance of the method as claimed in claims 1.

15. (canceled)
